(19) United States
(12) Patent Application Publication
(10) Pub. No.: US 2021/0081976 A1
(43) Pub. Date: Mar. 18, 2021

(54) DATA PROCESSING METHOD AND APPARATUS, AND STORAGE MEDIUM

(71) Applicant: Beijing Sensetime Technology Development Co., Ltd., Beijing (CN)

(72) Inventors: Wenhao DING, Beijing (CN); Chen CHEN, Beijing (CN)

(21) Appl. No.: 17/102,559

(22) Filed: Nov. 24, 2020

Related U.S. Application Data
(63) Continuation of application No. PCT/CN2020/098940, filed on Jun. 29, 2020.

(30) Foreign Application Priority Data
Aug. 14, 2019 (CN) 201910750535.3

(51) Int. Cl. G06Q 30/02; G06Q 50/30; G06K 9/00

(52) U.S. Cl. CPC G06Q 30/0205; G06K 9/00711; G06Q 50/30

(57) ABSTRACT

Examples of the present application disclose a data processing method and apparatus, and a storage medium. According to the data processing method, stay time length information of a target person for each of a plurality of vehicle models is obtained, wherein the stay time length information is determined based on at least one visit of the target person. An attention vehicle model of the target person is determined based on the stay time length information for each vehicle model. Information of the attention vehicle model of the target person is sent to a terminal. Thus, the terminal displays the information of the attention vehicle model of the target person on a first interface.

### CROSS REFERENCE TO RELATED APPLICATIONS

The present application is a continuation of International Patent Application Serial No. PCT/CN2020/098940 filed on Jun. 29, 2020. International Patent Application Serial No. PCT/CN2020/098940 claims priority to Chinese Patent Application No. 201910750535.3 filed on Aug. 14, 2019. The entire contents of each of the referenced applications are incorporated herein by reference for all purposes.

### TECHNICAL FIELD

The present application relates to the field of computer vision, and in particular, to a data processing method and apparatus, and a storage medium.

### BACKGROUND

In the market, sales people tend to serve different target persons with different reception strategies in order to increase sales conversion rates. Therefore, it is important to obtain personalized information of the target persons.

### SUMMARY

Examples of the present application propose a technical solution of data processing.

In a first aspect, an example of the present application provides a data processing method, including: identifying a target person from a captured video stream to obtain stay time length information of the target person for each of a plurality of vehicle models during at least one visit; generating tag information indicating an attention vehicle model of the target person based on the stay time length information for each vehicle model; and sending the tag information to a terminal provided with a first interface, so that the terminal displays the tag information on the first interface.

In an example, generating the tag information indicating the attention vehicle model of the target person based on the stay time length information for each vehicle model includes: determining the attention vehicle model of the target person based on the stay time length information for each vehicle model; generating the tag information based on the information of the attention vehicle model of the target person, wherein the tag information includes a stay time of the target person for the attention vehicle model.

In an example, determining the attention vehicle model of the target person based on the stay time length information for each vehicle model includes: determining a current attention vehicle model of the target person based on an accumulated stay time for which the target person in a vehicle model area corresponding to each of the plurality of vehicle models in a current visit; wherein the tag information comprises information of the current attention vehicle model of the target person; sending the tag information to the terminal includes: in response to detecting a next visit of the target person, sending a target person visit notifying message to the terminal, wherein the target person visit notifying message includes the tag information.

In an example, determining the attention vehicle model of the target person based on the stay time length information for each vehicle model includes: determining an overall-attention vehicle model of the target person based on an accumulated stay time for which the target person stays in a vehicle model area corresponding to each of the plurality of vehicle models in a current visit and at least one historical visit within a preset time period; wherein the tag information comprises information of the overall-attention vehicle model of the target person; sending the tag information to the terminal includes: sending a person-details updating message to the terminal, wherein the person-details updating message includes the tag information, so that the terminal updates a person-information interface of the target person.

In an example, determining the overall-attention vehicle model of the target person based on the accumulated stay time for which the target person stays in a vehicle model area corresponding to each of the plurality of vehicle models in the current visit and the at least one historical visit within the preset time period, includes: obtaining historical accumulated-stay-time information of the target person in the vehicle model area corresponding to each of the plurality of vehicle models in the at least one historical visit within the preset time period; obtaining updated accumulated-stay-time information of the target person based on an accumulated stay time for which the target person stays in the vehicle model area corresponding to each of the plurality of vehicle models in the current visit and the historical accumulated-stay-time information,; and determining the overall-attention vehicle model of the target person based on the updated accumulated-stay-time information of the target person.

In an example, identifying a target person from a captured video stream to obtain stay time length information of the target person for each of a plurality of vehicle models during at least one visit includes: performing identification processing on a captured video stream to obtain at least one image frame in which the target person appears in at least one visit; and determining a stay time length of the target person for each of the plurality of vehicle models based on a capturing time of the at least one image frame in which the target person appears and location information of the target person in each image frame.

In an example, determining the stay time length of the target person for each of the plurality of vehicle models includes: obtaining time information and location information corresponding to each appearance of the target person in the at least one image frame; determining the vehicle model area corresponding to each appearance based on location information of each appearance of the target person and the vehicle model areas corresponding to the plurality of vehicle models; and determining the stay time length of the target person for each of the plurality of vehicle models based on the time information corresponding to each appearance and the vehicle model area corresponding to each appearance.

In an example, determining the stay time length of the target person for each of the plurality of vehicle models based on the time information corresponding to each appearance and the vehicle model area corresponding to each appearance, includes: in response to that vehicle model areas corresponding to adjacent appearances of the target person are the same and a time difference between the adjacent appearances is less than or equal to a preset time threshold, counting the time difference corresponding to the adjacent appearances into a stay time length of the target person for a corresponding vehicle model area.

In an example, determining the stay time length of the target person for each of the plurality of vehicle models based on the time information corresponding to each appearance and the vehicle model area corresponding to each appearance, includes: in response to that the time difference between the adjacent appearances of the target person is greater than the preset time threshold, determining not to count the time difference between the adjacent appearances into the stay time length of the target person for the corresponding vehicle model areas.

In an example, the method further includes: receiving query conditions sent by the terminal, wherein the query conditions include at least identification information of the target person; querying for the attention vehicle model of the target person according to the query conditions; and sending the information of the attention vehicle model to the terminal.

In an example, the query conditions further include at least one of the following: a visited store name; visit time; or reception personnel identification.

In an example, determining the attention vehicle model of the target person based on the stay time length information for each vehicle model includes: sorting the plurality of vehicle models based on the stay time length information of the target person for each of the plurality of vehicle models to obtain an attention vehicle model list of the target person; wherein the tag information further includes at least a part of the attention vehicle model list of the target person.

In a second aspect, an example of the present application provides a data processing method. The method is applied to a terminal, and includes: receiving tag information indicating an attention vehicle model of a target person sent by a server; and displaying the tag information on a first interface, wherein the attention vehicle model of the target person is determined by the server based on stay time length information of the target person for each of a plurality of vehicle models.

In an example, the method further includes: receiving a person-details updating message of the target person sent by the server, wherein the person-details updating message includes information of an overall-attention vehicle model of the target person; and updating a person-information interface of the target person based on the person-details updating message.

In an example, the method further includes: receiving query conditions, wherein the query conditions include at least identification information of the target person; and sending the query conditions to the server, so that the server queries for the attention vehicle model of the target person according to the query conditions.

In a third aspect, an example of the present application provides a data processing apparatus, including: an obtaining module configured to identify a target person from a captured video stream to obtain stay time length information of the target person for each of a plurality of vehicle models during at least one visit; a determining module configured to generate tag information indicating an attention vehicle model of the target person based on the stay time length information for each vehicle model; and a sending and processing module configured to send the tag information to a terminal provided with a first interface, so that the terminal displays the tag information on the first interface.

In an example, the determining module is further configured to: determine the attention vehicle model of the target person based on the stay time length information for each vehicle model; generate the tag information based on the information of the attention vehicle model of the target person, wherein the tag information includes a stay time of the target person for the attention vehicle model.

In an example, the determining module is configured to, based on an accumulated stay time for which the target person stays in a vehicle model area corresponding to each of the plurality of vehicle models in a current visit, determine a current attention vehicle model of the target person; wherein the tag information comprises information of the current attention vehicle model of the target person; the sending and processing module is further configured to: in response to detecting a next visit of the target person, send a target person visit notifying message to the terminal, wherein the target person visit notifying message includes the tag information.

In an example, the determining module is configured to: determine an overall-attention vehicle model of the target person based on an accumulated stay time for which the target person stays in a vehicle model area corresponding to each of the plurality of vehicle models in a current visit and at least one historical visit within a preset time period; wherein the tag information comprises information of the overall-attention vehicle model of the target person; the sending and processing module is further configured to: send a person-details updating message to the terminal, wherein the person-details updating message includes the tag information, so that the terminal updates a person-information interface of the target person.

In an example, the determining module is configured to: obtain historical accumulated-stay-time information of the target person in the vehicle model area corresponding to each of the plurality of vehicle models in the at least one historical visit within the preset time period; obtain updated accumulated-stay-time information of the target person based on an accumulated stay time for which the target person stays in the vehicle model area corresponding to each of the plurality of vehicle models in the current visit and the historical accumulated-stay-time information; and determine the overall-attention vehicle model of the target person based on the updated accumulated-stay-time information of the target person.

In an example, the apparatus further includes a statistics module configured to: perform identification processing on a captured video stream to obtain at least one image frame in which the target person appears in at least one visit; and determine a stay time length of the target person for each of the plurality of vehicle models based on a capturing time of the at least one image frame in which the target person appears and location information of the target person in each image frame.

In an example, the statistics module is configured to: obtain time information and location information corresponding to each appearance of the target person in the at least one image frame; determine the vehicle model area corresponding to each appearance based on the location information of each appearance of the target person and the vehicle model areas corresponding to the plurality of vehicle models; and determine the stay time length of the target person for each of the plurality of vehicle models based on the time information corresponding to each appearance and the vehicle model area corresponding to each appearance.

In an example, the statistics module is configured to: in response to that vehicle model areas corresponding to adjacent appearances of the target person are the same and a time difference between the adjacent appearances is less than or equal to a preset time threshold, count the time difference between the adjacent appearances into a stay time length of the target person in the corresponding vehicle model area.

In an example, the statistics module is configured to: in response to that the time difference between the adjacent appearances of the target person is greater than the preset time threshold, determine not to count the time difference between the adjacent appearances to the stay time length of the target person in the corresponding vehicle model areas.

In an example, the obtaining module is further configured to obtain information of a historical attention vehicle model of the target person; the determining module is further configured to determine a candidate vehicle model of the target person based on the attention vehicle model and the information of the historical attention vehicle model of the target person.

In an example, the apparatus further includes: a receiving and processing module configured to receive query conditions sent by the terminal, wherein the query conditions include at least identification information of the target person; and a querying module configured to query for the attention vehicle model of the target person according to the query conditions; the sending and processing module is further configured to send the information of the attention vehicle model to the terminal.

In an example, the query conditions further include at least one of the following: a visited store name; a visit time; or reception personnel identification.

In an example, the determining module is configured to sort the plurality of vehicle models based on the stay time length information of the target person for each of the plurality of vehicle models to obtain an attention vehicle model list of the target person; wherein the tag information further includes at least a part of the attention vehicle model list of the target person.

In a fourth aspect, an example of the present application provides a data processing apparatus. The apparatus is applicable to a terminal, and includes: a communicating module configured to receive tag information indicating an attention vehicle model of a target person sent by a server; and a displaying and processing module configured to display the tag information on a first interface, wherein the attention vehicle model of the target person is determined by the server based on stay time length information of the target person for each of a plurality of vehicle models.

In an example, the communicating module is further configured to receive a person-details updating message of the target person sent by the server, wherein the person-details updating message includes information of an overall-attention vehicle model of the target person; the apparatus further includes: an updating module configured to update a person-information interface of the target person based on the person-details updating message.

In an example, the apparatus further includes: an inputting module configured to receive query conditions, wherein the query conditions include at least identification information of the target person; and the communicating module is further configured to send the query conditions to the server, so that the server queries for the attention vehicle model of the target person according to the query conditions.

In a fifth aspect, an example of the present application provides a data processing apparatus, including: a memory, a processor and a computer program stored in the memory and running on the processor, wherein the program is executed by the processor to perform the steps in the data processing method applied to the server as described in the example of the present application.

In a sixth aspect, an example of the present application provides a storage medium, having a computer program stored thereon, wherein the program is executed by the processor to perform the steps in the data processing method applied to the server as described in the example of the present application.

In a seventh aspect, an example of the present application provides a data processing apparatus, including: a memory, a processor and a computer program stored in the memory and running on the processor, wherein the program is executed by the processor to perform the steps in the data processing method applied to the terminal as described in the example of the present application.

In an eighth aspect, an example of the present application provides a storage medium, having a computer program stored thereon, wherein the program is executed by the processor to perform the steps in the data processing method applied to the terminal as described in the example of the present application.

In a ninth aspect, an example of the present application provides a computer program, including computer readable codes, wherein the computer readable codes, when running in an electronic device, are executed by a processor in the electronic device to implement the data processing method as described in the example of the present application.

According to the technical solutions provided in the examples of the present application, the stay time length information of the target person for the plurality of vehicle models is obtained, wherein the stay time length information is determined based on the at least one visit of the target person; the attention vehicle model of the target person is determined based on the stay time length information; and the information of the attention vehicle model of the target person is sent to the terminal, so that the terminal displays the information of the attention vehicle model of the target person on the first interface. In this way, by analyzing a stay time length of each target person for different vehicle models, an attention vehicle model of each target person is determined, which is convenient for the sales personnel to provide the target person with targeted service easily based on the attention vehicle model of the target person, improving the target person's experience and sales conversion rate.

It should be understood that the above general description and the following detailed description are only exemplary and explanatory and are not restrictive of the present disclosure.

### BRIEF DESCRIPTION OF THE DRAWINGS

The accompanying drawings, which are incorporated in and constitute a part of this specification, illustrate examples consistent with the present disclosure and, together with the description, serve to explain the technical solutions of the disclosure.

With reference to the drawings, the application may be understood more clearly according to the following detailed description.

FIG. 1A is a first schematic diagram illustrating an implementation process of a data processing method according to an example of the present application.

FIG. 1B is a second schematic diagram illustrating an implementation process of a data processing method according to an example of the present application.

FIG. 2 is a third schematic diagram illustrating an implementation process of a data processing method according to an example of the present application.

FIG. 3 is a schematic diagram illustrating an attention vehicle model display interface according to an example of the present application.

FIG. 4 is a first schematic diagram illustrating a structure of a data processing apparatus according to an example of the present application.

FIG. 5 is a second schematic diagram illustrating a structure of a data processing apparatus according to an example of the present application.

### DETAILED DESCRIPTION OF THE EMBODIMENTS

Various exemplary embodiments, features and aspects of the present disclosure will be described in detail below with reference to the drawings. The same reference signs in the drawings indicate elements with the same or similar functions. Although various aspects of the embodiments are shown in the drawings, the drawings are not necessarily drawn to scale unless otherwise indicated.

The word “exemplary” specially used herein means “serving as an example, an embodiment, or illustration”. Any embodiment described herein as “exemplary” need not be construed as being superior or better than other embodiments.

The term “and/or” herein is only an association relationship describing associated objects, and means that there may be three relationships, for example, A and/or B, which may refer to three cases in which A exists alone, A and B exist at the same time, and B exists alone. In addition, the term “at least one” herein means any one of a plurality or any combination of at least two of the plurality, for example, at least one of A, B and C is included, which may refer to that any one or more elements selected from a set consisting of A, B and C are included.

In addition, in order to better illustrate the examples of the present disclosure, numerous details are given in the following specific embodiments. Those skilled in the art should understand that the examples of the present disclosure may also be implemented without certain details. In some instances, methods, means, elements and circuits well-known to those skilled in the art are not described in detail in order to highlight the gist of the examples of the present disclosure.

It can be understood that method examples mentioned in the present disclosure may be combined with each other to form combined examples without departing from the principle of the present invention, and will not be repeated in order to avoid redundancy.

In order to enable those skilled in the art to better understand the technical solutions in the examples of the present application, the technical solutions in the examples of the present application will be clearly described below in conjunction with the drawings therein. Obviously, the described examples are only a part but not all of the examples of the present application.

The terms “first”, “second” and “third” in the examples of the specification, claims and drawings of the present application are used to distinguish similar objects, but are not necessarily used to describe a particular order or a sequential order. In addition, the terms “including”, “having” and any variations thereof are intended to cover non-exclusive inclusion, for example, a series of steps or units are included. The methods, systems, products or devices are not necessarily limited to those clearly listed steps or units, but may include other steps or units that are not clearly listed or are inherent to these processes, methods, products or devices.

In an example of the present application, a data processing method is provided, which is applicable to a server or other electronic device. The server may be a cloud server or an ordinary server. The electronic device may be User Equipment (UE), a mobile device, a user terminal, a cell phone, a cordless phone, a Personal Digital Assistant (PDA), a handheld device, a computing device, a vehicle-mounted device, a wearable device, etc.

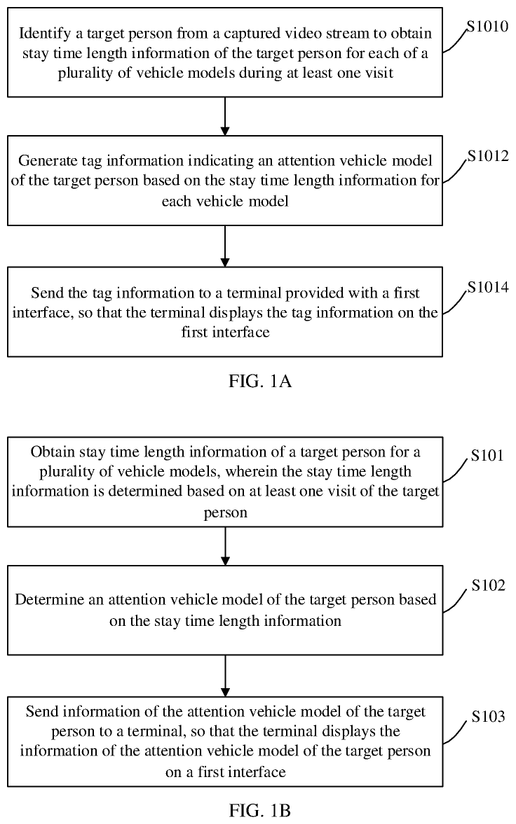

As shown in FIG. 1A, according to the method, at step S1010, the server may identify a target person from a captured video stream to obtain stay time length information of the target person for each of a plurality of vehicle models during at least one visit; at step S1012, generate tag information indicating an attention vehicle model of the target person based on the stay time length information for each vehicle model; and at step S1014, send the tag information to a terminal provided with a first interface, so that the terminal displays the tag information on the first interface.

In another example of the present application, a data processing method is provided. As shown in FIG. 1, the method mainly includes the following steps.

At step S101, stay time length information of a target person for each of a plurality of vehicle models during at least one visit of the target person is obtained.

Here, the target person may be understood as any person in an automobile 4S store.

It is understood that any person on a whitelist is not regarded as a target person.

The whitelist includes at least one of the following: employees, cleaning workers, maintenance men, couriers and delivery men in the 4S store.

It should be noted that the whitelist may be set or adjusted according to user requirements.

In some examples, a method for determining a stay time length of a target person for each of a plurality of vehicle models includes:

performing identification processing on a captured video stream to obtain at least one image frame in which the target person appears in one visit; and

determining the stay time length of the target person for each of the plurality of vehicle models based on a capturing time of the at least one image frame in which the target person appears and location information of the target person in the image frame.

In an example, images of customers in an automobile 4S store are captured by an image capturing apparatus, then the captured images are analyzed to recognize target persons, and a stay time length of each target person for each of a plurality of vehicle models is obtained according to image capturing time information and location information.

In an example, when the images captured by the image capturing apparatus are analyzed, it is first determined whether a currently identified object belongs to a whitelisted person. If the currently identified object belongs to the whitelisted person, the currently identified object is ignored. If the currently identified object does not belong to the whitelisted person, the currently identified object is determined to be a target person, and a stay time length of the target person for each of a plurality of vehicle models is analyzed.

In some embodiments, determining the stay time length of the target person for each of the plurality of vehicle models includes:

obtaining time information and location information corresponding to at least one appearance of the target person in a video image;

determining a vehicle model area corresponding to each appearance of the target person based on location information of each appearance and the vehicle model areas corresponding to the plurality of vehicle models; and

determining the stay time length of the target person for each of the plurality of vehicle models based on the time information corresponding to each appearance and the vehicle model area corresponding to each appearance.

Here, the vehicle model area is larger than or equal to an area occupied by a single vehicle, and the vehicle model area may be delineated automatically by a system or delineated manually.

It should be noted that a corresponding relationship between a vehicle model and a vehicle model area may be set manually by a user, or set automatically by a system based on the shape and identification of a vehicle itself, for example.

In practical applications, each vehicle model area may have an independent serial number, and each vehicle model may correspond to one or more vehicle model areas.

For example, each vehicle model corresponds to one vehicle model area. Exemplarily, a car with a vehicle model Haval H6 is displayed in a vehicle model area 1, a car with a vehicle model Haval H7 is displayed in a vehicle model area 2, a car with a vehicle model Haval M6 is displayed in a vehicle model area 3, and a car with a vehicle model Haval F7 is displayed in a vehicle model area 4.

For another example, the same vehicle model may correspond to one or more vehicle model areas. Exemplarily, a car with a vehicle model Haval H6 is displayed in vehicle model areas 1 and 2, a car with a vehicle model Haval H7 is displayed in vehicle model areas 3 and 4, a car with a vehicle model Haval M6 is displayed in a vehicle model area 5, and a car with a vehicle model Haval F7 is displayed in a vehicle model area 6. In some specific examples, determining the stay time length of the target person for each of the plurality of vehicle models based on the time information corresponding to each appearance and the vehicle model area corresponding to each appearance, includes:

in response to that the vehicle model areas corresponding to adjacent appearances of the target person are the same and a time difference between the adjacent appearances is less than or equal to a preset time threshold, counting the time difference between the adjacent appearances into a stay time length for which the target person stays in the corresponding vehicle model area.

In some specific examples, determining the stay time length of the target person for each of the plurality of vehicle models based on the time information corresponding to each appearance and the vehicle model area corresponding to each appearance, includes:

in response to that the time difference between the adjacent appearances of the target person is greater than the preset time threshold, determining not to count the time difference between the adjacent appearances into the stay time length for which the target person stays in the corresponding vehicle model area.

It should be noted that the preset time threshold may be set or adjusted according to actual conditions or user requirements.

Exemplarily, it is assumed that the preset time threshold is 5 minutes, and a front-end server responsible for image capturing and image identification processing sends a message every 1 minute to a back-end server responsible for attention vehicle model analysis. The message includes time information and location information of each target person. The back-end server receives a message about visit information of a target person A, specifically indicating appearance of the target person A in a first vehicle model area at 9:00. At a 7^{th} minute, the back-end server receives the message about the visit information of the target person A, specifically indicating the appearance of the target person A in the first vehicle model area at 9:07. At 2^{nd}, 3^{rd}, 4^{th}, 5^{th} and 6^{th} minutes, the back-end server does not receive the message about the visit information of the target person A. Thereby, the back-end server determines that the target person A is actually only snapshotted, and a stay time length of the target person A is not recorded.

Exemplarily, it is assumed that at a 1^{st} minute, the back-end server receives a message about visit information of a target person B, specifically indicating appearance of the target person B in the first vehicle model area at 9:01. At a 2^{nd} minute, the back-end server receives the message about the visit information of the target person B, specifically indicating the appearance of the target person B in a second vehicle model area at 9:02. At 3^{rd}, 4^{th}, 5^{th}, 6^{th} and 7^{th} minutes, the back-end server does not receive the message about the visit information of the target person B. Thereby, the back-end server determines that the target person B has actually left, and a stay time length of the target person B is not recorded.

Exemplarily, it is assumed that at a 1^{st} minute, the back-end server receives a message about visit information of a target person C, specifically indicating appearance of the target person C in the first vehicle model area at 9:01. At a 2^{nd} minute, the back-end server receives the message about the visit information of the target person C, specifically indicating the appearance of the target person C in a second vehicle model area at 9:02. At 3^{rd}, 4^{th}, 5^{th}, 6^{th} and 7^{th} minutes, the back-end server does not receive the message about the visit information of the target person C. Thereby, the back-end server determines that a stay time length of the target person C in the first vehicle model area is 1 minute.

In this way, the preset time threshold is set to determine a stay time length of each target person for a vehicle model, thereby providing a more reasonable and more accurate data basis for determining an attention vehicle model of the target person.

At step S102, an attention vehicle model of the target person is determined based on the stay time length information.

In an example, determining the attention vehicle model of the target person based on the stay time length information includes:

comparing the stay time lengths of the target person for each vehicle model; and

determining an attention vehicle model of the target person according to a comparison result.

In an example, determining the attention vehicle model of the target person according to the comparison result includes:

determining, for the target person, top N vehicle models in the descending order of stay time length as attention vehicle models of the target person, wherein N is a positive integer.

That is to say, it may be finally determined that there are a plurality of attention vehicle models for each target person.

In this way, the stay time lengths of the target person for each vehicle model are compared to determine the degree of preference and attention of the target person to each vehicle model in a store.

At step S103, information of the attention vehicle model of the target person is sent to a terminal, so that the terminal displays the information of the attention vehicle model of the target person on a first interface.

In some examples, sending the information of the attention vehicle model of the target person to the terminal includes:

sending the information of the attention vehicle model of the target person as tag information of the target person to the terminal,

wherein the tag information includes a stay time of the target person for the attention vehicle model.

In this way, the attention vehicle model of the target person is sent to the terminal by adding a tag of the attention vehicle mode to the target person, which is convenient for the sales personnel to know the attention vehicle model of the target person in time and provide the target person with targeted service based on the attention vehicle model of the target person, improving the target person's experience and sales conversion rate.

In an example, the tag information further includes at least one of the following:

contact information of the target person;

a latest visit time corresponding to the attention vehicle model;

historical visit times and historical stay times corresponding to the attention vehicle model;

an accumulated stay time length corresponding to the attention vehicle model; or

an accumulated number of visits corresponding to the attention vehicle model.

Here, the contact information includes, but is not limited to, a mobile phone number, a WeChat ID, a mailbox, a QQ number, etc.

In this way, the terminal may know and display the tag information of the target person, which is more convenient for sales personnel to know the attention vehicle model of the target person in time and provide the target person with targeted service based on the attention vehicle model of the target person, improving the target person's experience and sales conversion rate.

In some examples, determining the attention vehicle model of the target person based on the stay time length information includes: based on an accumulated stay time for which the target person stays in the vehicle model area corresponding to each of the plurality of vehicle models in a current visit, determining a current attention vehicle model of the target person in the current visit; sending the information of the attention vehicle model of the target person to the terminal includes: in response to detecting a next visit of the target person, sending a person visit notifying message to the terminal, wherein the person visit notifying message includes information of the current attention vehicle model of the target person.

In some examples, determining the attention vehicle model of the target person based on the stay time length information includes: based on an accumulated stay time for which the target person stays in the vehicle model area corresponding to each of the plurality of vehicle models in a current visit and at least one historical visit within a preset time period, determining an overall-attention vehicle model of the target person; sending the information of the attention vehicle model of the target person to the terminal includes: sending a person-details updating message to the terminal, wherein the person-details updating message includes information of the overall-attention vehicle model of the target person, so that the terminal updates a person-information interface of the target person.

Here, the preset time period may be set or adjusted according to user requirements.

In an example, based on the accumulated stay time for which the target person stays in the vehicle model area corresponding to each of the plurality of vehicle models in the current visit and the at least one historical visit within the preset time period, determining the overall-attention vehicle model of the target person includes: obtaining historical accumulated-stay-time information of the target person for the vehicle model area corresponding to each of the plurality of vehicle models in the at least one historical visit within the preset time period; based on an accumulated stay time for which the target person stays in the vehicle model area corresponding to each of the plurality of vehicle models in the current visit and the historical accumulated-stay-time information, obtaining updated accumulated-stay-time information of the target person; and based on the updated accumulated-stay-time information of the target person, determining the overall-attention vehicle model of the target person.

In this way, a change in the attention vehicle model of the target person may be determined by the analysis for the attention vehicle model of the target person within the preset time period, so as to have a more accurate understanding of the target person.

In some examples, determining the attention vehicle model of the target person based on the stay time length information includes:

sorting the plurality of vehicle models based on the stay time length information of the target person for each of the plurality of vehicle models to obtain an attention vehicle model list of the target person;

correspondingly, sending the information of the attention vehicle model of the target person to the terminal includes:

sending at least a part of the attention vehicle model list of the target person to the terminal.

In some examples, the method further includes:

obtaining information of historical attention vehicle models of the target person; and

determining a candidate vehicle model of the target person based on the current attention vehicle model and the information of the historical attention vehicle models of the target person.

In this way, the candidate vehicle model of the target person is determined based on the current attention vehicle model and the information of the historical attention vehicle models of the target person. In such way, when the target person visits next time, it is convenient for sales personnel to provide the target person with targeted service, improving the target person's experience and sales conversion rate.

In some alternative examples, the method further includes:

receiving query conditions sent by the terminal, wherein the query conditions include at least identification information of the target person;

querying for the attention vehicle model of the target person according to the query conditions; and

sending the information of the attention vehicle model to the terminal.

The query conditions further include at least one of the following: a visited store name; a visit time; or reception personnel identification.

In this way, attention vehicle models that match query conditions input by sales personnel may be fed back to the terminal in time, which is convenient for the sales personnel to know attention vehicle models of the target person in time in different environments, such as environments at different times and different locations.

The technical solution described in this example proposes a data processing method.

The attention vehicle model of the target person is determined by automatically identifying the stay time length of the target person for each vehicle model in the store. Such way is easy, convenient and saves time and energy of the sales personnel, as compared with manually recording or inferring the attention vehicle model of the target person by the sales personnel.

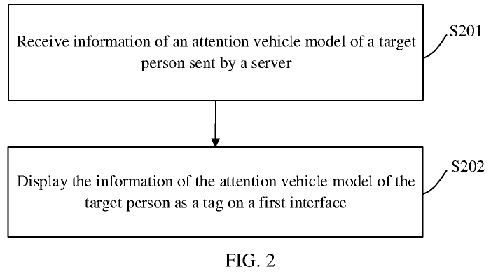

An example of the present application provides a data processing method, which is applicable to a terminal. As shown in FIG. 2, the method mainly includes the following steps.

At step S201, information of an attention vehicle model of a target person sent by a server is received.

The attention vehicle model of the target person is determined by the server based on stay time length information of the target person for each of a plurality of vehicle models.

At step S202, the information of the attention vehicle model of the target person is displayed as a tag on a first interface.

In an example, the tag further includes at least one of the following information:

contact information of the target person;

latest visit time corresponding to the attention vehicle model;

historical visiting time and historical stay time corresponding to the attention vehicle model;

an accumulated stay time length corresponding to the attention vehicle model; or

an accumulated number of visits corresponding to the attention vehicle model.

Here, the contact information includes, but is not limited to, a mobile phone number, a WeChat ID, a mailbox, a QQ number, etc.

In this way, the terminal displays the tag of the target person, which is more convenient for the sales personnel to know the attention vehicle model of the target person in time and provide the target person with targeted service based on the attention vehicle model of the target person, improving the target person's experience and sales conversion rate.

In some examples, the method further includes:

receiving a person-details updating message of the target person sent by the server, wherein the person-details updating message includes information of an overall-attention vehicle model of the target person; and

updating a person-information interface of the target person based on the person-details updating message.

In this way, a change in the attention vehicle model of the target person may be updated in time so as to have a more accurate understanding of and follow-up to the target person.

In some examples, the method further includes:

receiving query conditions, wherein the query conditions include at least identification information of the target person; and

sending the query conditions to the server, so that the server queries for the attention vehicle model of the target person according to the query conditions.

In this way, attention vehicle models of the target person that match the query conditions may be known.

Here, different target persons have different identifications. An identification is a representation that may distinguish a target person from another target person.

For example, the identification may be an ID number, a mobile phone number, a WeChat ID, etc.

For another example, the identification may also be an image including a face or body feature of a target person.

In some alternative examples, the query conditions further include one or more of the following:

a visited store name; a visit time; or reception personnel identification.

In some examples, displaying the attention vehicle model of the target person includes:

displaying the attention vehicle model of the target person through tag information, wherein the tag information includes the attention vehicle model.

The technical solution described in this example proposes a data processing method. The sales personnel input the query conditions on a terminal side, and the terminal may display attention vehicle models of the target person that match the query conditions, which is easy, convenient and saves time and energy of the sales personnel as compared with manually recording or inferring the attention vehicle model of the target person by the sales personnel. Since the sales personnel may know the attention vehicle model of the target person in time, it is convenient for the sales personnel to provide the target person with targeted service based on the attention vehicle model of the target person, improving the target person's experience and sales conversion rate.

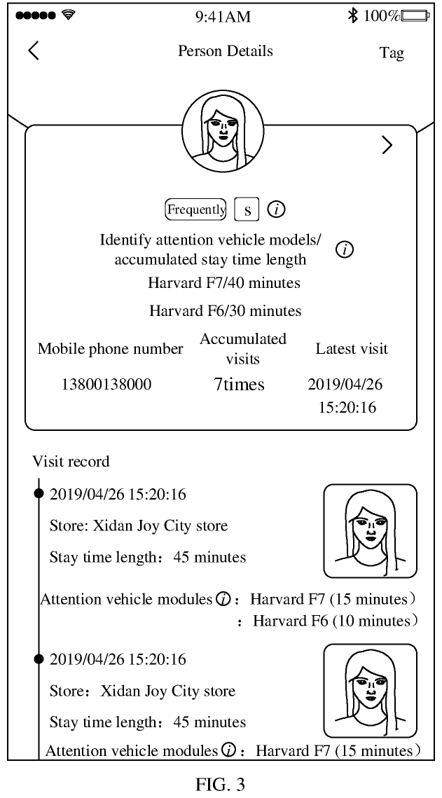

FIG. 3 shows an attention vehicle model display interface. As shown in FIG. 3, an attention vehicle model of a target person, and an accumulated stay time length, an accumulated number of visits and latest visit time corresponding to the attention vehicle model are displayed on the display interface. The attention vehicle model and a visit record of the target person in each visit such as a store name, visit time, an attention vehicle model and a stay time length corresponding to each attention vehicle model are also displayed on the display interface. At the same time, an image of the target person such as an avatar, a name of the target person such as Ms. Zhang, contact information of the target person such as a mobile phone number and other information are displayed on the display interface.

A method for calculating attention vehicle models in a visit record includes:

if a target person arrived at a store yesterday, stay time lengths of the target person in vehicle model areas yesterday were calculated, stay time lengths of the target person in the same vehicle model area were accumulated, and top x vehicle models in rankings of sums of the accumulated stay time lengths are regarded as attention vehicle models of the target person in the visit yesterday.

In practical applications, only the top x vehicle models in rankings of the stay time lengths are displayed during the displaying. Vehicle models behind the top x vehicle models in the rankings of the stay time lengths are not displayed.

It should be noted that if only top x-i vehicle models in the rankings of the stay time lengths can be determined, only the top x-i vehicle models are displayed, wherein 1≤i≤x.

It should be noted that if a target person is not snapshotted in a vehicle model area in his/her visit on a day and his/her stay time length is not recorded, an attention vehicle model display text on this day is: no attention vehicle model. If a result of calculating a stay time length for a vehicle model is 0, it is determined that there is no stay time length for this vehicle model. Since there is no calculation result, such case is not displayed on an interface.

Through the display interface, the sales personnel may know attention vehicle models of the target person in previous visits, which assists the sales personnel in following up and selling to the target person.

In practical applications, if data of each target person cannot be buffered in real time due to a larger cloud server traffic, a T-1 calculation method may be adopted. A timed task runs at a fixed time every day to select stores and customers that need to be calculated. A stay time length of each customer in each vehicle model area is calculated, and data of top N vehicle models in rankings of stay time lengths and stay time lengths thereof are stored for subsequent query.

Exemplarily, attention vehicle models with a time D1 are queried for. If the D1 is visit time on current day, and data on this day has not been calculated, it is prompted that an attention vehicle model on the day has not been calculated; if D1 is visit time in a past day, the calculated attention vehicle models in previous visits may be read.

It should be understood that the display interface shown in FIG. 3 is an alternative specific implementation, which is not limited thereto.

It should also be understood that the display interface shown in FIG. 3 is only for illustrating the example of the present application. Those skilled in the art may make all kinds of obvious changes and/or replacements based on the example of FIG. 3, and the obtained technical solutions still fall into the disclosure scope of the examples of the present application.

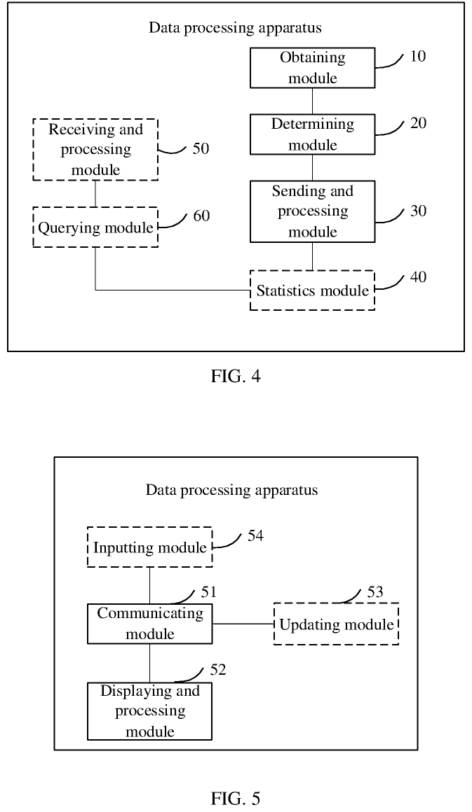

Corresponding to the data processing methods, an example of the present application provides a data processing apparatus. As shown in FIG. 4, the apparatus includes:

an obtaining module 10 configured to identify a target person from a captured video stream to obtain stay time length information of the target person for each of a plurality of vehicle models during at least one visit;
a determining module 20 configured to generate tag information indicating an attention vehicle model of the target person based on the stay time length information for each vehicle model; and
a sending and processing module 30 configured to send the tag information to a terminal provided with a first interface, so that the terminal displays the tag information on the first interface.

In some examples, the determining module 20 is further configured to:

determine the attention vehicle model of the target person based on the stay time length information for each vehicle model;
generate the tag information based on the information of the attention vehicle model of the target person,
wherein the tag information includes a stay time of the target person for the attention vehicle model.

In some examples, the determining module 20 is configured to, based on an accumulated stay time for which the target person stays in a vehicle model area corresponding to each of the plurality of vehicle models in a current visit, determine a current attention vehicle model of the target person;

wherein the tag information comprises information of the current attention vehicle model of the target person;
the sending and processing module 30 is further configured to:
in response to detecting a next visit of the target person, send a person visit notifying message to the terminal, wherein the person visit notifying message includes the tag information.

In some examples, the determining module 20 is configured to:

determine an overall-attention vehicle model of the target person based on an accumulated stay time of the target person in a vehicle model area corresponding to each of the plurality of vehicle models in a current visit and at least one historical visit within a preset time period;
wherein the tag information comprises information of the overall-attention vehicle model of the target person;
the sending and processing module 30 is further configured to:
send a person-details updating message to the terminal, wherein the person-details updating message includes the tag information, so that the terminal updates a person-information interface of the target person.

In some examples, the determining module 20 is configured to:

obtain historical accumulated-stay-time information of the target person in the vehicle model area corresponding to each of the plurality of vehicle models in the at least one historical visit within the preset time period;
obtain updated accumulated-stay-time information of the target person based on an accumulated stay time for which the target person stays in the vehicle model area corresponding to each of the plurality of vehicle models in the current visit and the historical accumulated-stay-time information; and
determine the overall-attention vehicle model of the target person based on the updated accumulated-stay-time information of the target person.

In some examples, the apparatus further includes a statistics module 40 configured to:

perform identification processing on a captured video stream to obtain at least one image frame in which the target person appears in at least one visit; and
determine a stay time length of the target person for each of the plurality of vehicle models based on a capturing time of the at least one image frame in which the target person appears and location information of the target person in each image frame.

In some examples, the statistics module 40 is configured to:

obtain time information and location information corresponding to each appearance of the target person in the at least one image frame;
determine the vehicle model area corresponding to each appearance based on location information of each appearance of the target person and the vehicle model areas corresponding to the plurality of vehicle models; and
determine the stay time length of the target person for each of the plurality of vehicle models based on the time information corresponding to each appearance and the vehicle model area corresponding to each appearance.

In some examples, the statistics module 40 is configured to:

in response to that vehicle model areas corresponding to adjacent appearances of the target person are the same and a time difference between the adjacent appearances is less than or equal to a preset time threshold, count the time difference between the adjacent appearances into a stay time length of the target person in the corresponding vehicle model area.

In some examples, the statistics module 40 is configured to:

in response to that the time difference between the adjacent appearances of the target person is greater than the preset time threshold, determine not to count the time difference between the adjacent appearances into the stay time length of the target person for the corresponding vehicle model area.

In an example, the apparatus further includes:

a receiving and processing module 50 configured to receive query conditions sent by the terminal, wherein the query conditions include at least identification information of the target person; and
a querying module 60 configured to query for the attention vehicle model of the target person according to the query conditions;
the sending and processing module 30 is further configured to send the information of the attention vehicle model to the terminal.

In an example, the query conditions further include at least one of the following:

a visited store name; visit time; or reception personnel identification.

In an example, the determining module 20 is configured to: sort the plurality of vehicle models based on the stay time length information of the target person for each of the plurality of vehicle models to obtain an attention vehicle model list of the target person;

wherein the tag information further includes at least a part of the attention vehicle model list of the target person.

Those skilled in the art should understand that implementation functions of each processing module in the data processing apparatus shown in FIG. 4 may be understood with reference to the relevant description of the data processing method. Those skilled in the art should understand that functions of each processing unit in the data processing apparatus shown in FIG. 4 may be implemented by a program running on a processor, or by a specific logic circuit.

In practical applications, all specific structures of the obtaining module 10, the determining module 20, the sending and processing module 30, the statistics module 40, the receiving and processing module 50, and the querying module 60 may correspond to the processor. The specific structure of the processor may be a Central Processing Unit (CPU), a Micro Controller Unit (MCU), a Digital Signal Processing (DSP), a Programmable Logic Controller (PLC), electronic components having a processing function or collections of the electronic components. The processor includes an executable code. The executable code is stored in a storage medium. The processor may be connected to the storage medium through a communication interface such as a bus. When corresponding functions of each specific unit are performed, the executable code is read from the storage medium and executed. A part of the storage medium for storing the executable code is preferably a non-transitory storage medium.

The data processing apparatus provided by the example of the present application may automatically determine the attention vehicle model of the target person, which is easy, convenient and saves time and energy of the sales personnel as compared with manually recording or inferring the attention vehicle model of the target person by the sales personnel, and is further convenient for the sales personnel to know the attention vehicle model of the target person in time and provide the target person with targeted service based on the attention vehicle model of the target person, improving the target person's experience and sales conversion rate.

An example of the present application also describes a data processing apparatus. The apparatus includes a memory, a processor and a computer program stored in the memory and running on the processor, wherein the program is executed by the processor to implement the data processing method provided in any of the technical solutions applied to the server as described above.

In an example, the program is executed to cause the processor to:

identify a target person from a captured video stream to obtain stay time length information of the target person for each of a plurality of vehicle models during at least one visit;
generate tag information indicating an attention vehicle model of the target person based on the stay time length information for each vehicle model; and
send the tag information to a terminal provided with a first interface, so that the terminal displays the tag information on the first interface.

In an example, the program is executed to cause the processor to:

determine the attention vehicle model of the target person based on the stay time length information for each vehicle model;
generate the tag information based on the information of the attention vehicle model of the target person,
wherein the tag information comprises a stay time of the target person for the attention vehicle model.

In an example, the program is executed to cause the processor to:

determine a current attention vehicle model of the target person based on an accumulated stay time for which the target person stays in a vehicle model area corresponding to each of the plurality of vehicle models in a current visit;
wherein the tag information comprises information of the current attention vehicle model of the target person;
when sending the tag information to the terminal, the processor is further caused to:
in response to detecting a next visit of the target person, send a person visit notifying message to the terminal, wherein the person visit notifying message comprises the tag information.

In an example, the program is executed to cause the processor to:

determine an overall-attention vehicle model of the target person based on an accumulated stay time for which the target person stays in a vehicle model area corresponding to each of the plurality of vehicle models in a current visit and at least one historical visit within a preset time period;
wherein the tag information comprises information of the overall-attention vehicle model of the target person;
when sending the tag information to the terminal, the processor is further caused to:
send a person-details updating message to the terminal, wherein the person-details updating message comprises the tag information, so that the terminal updates a person-information interface of the target person.

In an example, the program is executed to cause the processor to:

obtain historical accumulated-stay-time information of the target person in the vehicle model area corresponding to each of the plurality of vehicle models in the at least one historical visit within the preset time period;
obtain updated accumulated-stay-time information of the target person based on an accumulated stay time for which the target person stays in the vehicle model area corresponding to each of the plurality of vehicle models in the current visit and the historical accumulated-stay-time information; and
determine the overall-attention vehicle model of the target person based on the updated accumulated-stay-time information of the target person.

In an example, the program is executed to cause the processor to:

perform identification processing on a captured video stream to obtain at least one image frame in which the target person appears in at least one visit; and
determine a stay time length of the target person for each of the plurality of vehicle models based on capturing time of the at least one image frame in which the target person appears and location information of the target person in each image frame.

In an example, the program is executed to cause the processor to:

obtain time information and location information corresponding to each appearance of the target person in the at least one image frame;
determine the vehicle model area corresponding to each appearance based on the location information of each appearance of the target person and the vehicle model areas corresponding to the plurality of vehicle models; and
determine the stay time length of the target person for each of the plurality of vehicle models based on the time information corresponding to each appearance and the vehicle model area corresponding to each appearance.

In an example, the program is executed to cause the processor to:

in response to that vehicle model areas corresponding to adjacent appearances of the target person are the same and a time difference between the adjacent appearances is less than or equal to a preset time threshold, count the time difference between the adjacent appearances into a stay time length of the target person for a corresponding vehicle model area.

In an example, the program is executed to cause the processor to:

in response to that the time difference between the adjacent appearances of the target person is greater than the preset time threshold, determine not to count the time difference between the adjacent appearances into the stay time length of the target person for the corresponding vehicle model area.

In an example, the program is executed to cause the processor to:

receive query conditions sent by the terminal, wherein the query conditions comprise at least identification information of the target person.

In an example, the query conditions further comprise at least one of the following:

a visited store name; a visit time; or reception personnel identification.

In an example, the program is executed to cause the processor to:

sort the plurality of vehicle models based on the stay time length information of the target person for each of the plurality of vehicle models to obtain an attention vehicle model list of the target person;
wherein the tag information further comprises at least a part of the attention vehicle model list of the target person.

The data processing apparatus provided by the example of the present application may automatically determine the attention vehicle model of the target person, which is easy, convenient and saves time and energy of the sales personnel as compared with manually recording or inferring the attention vehicle model of the target person by the sales personnel, and is further convenient for the sales personnel to know the attention vehicle model of the target person in time and provide the target person with targeted service based on the attention vehicle model of the target person, improving the target person's experience and sales conversion rate.

Corresponding to the data processing method, an example of the present application provides a data processing apparatus, which is applicable to a terminal. As shown in FIG. 5, the apparatus includes:

a communicating module 51 configured to receive tag information indicating an attention vehicle model of a target person sent by a server; and
a displaying and processing module 52 configured to display the tag information on a first interface,
wherein the attention vehicle model of the target person is determined by the server based on stay time length information of the target person for each of a plurality of vehicle models.

In some examples, the communicating module 51 is further configured to receive a person-details updating message of the target person sent by the server, wherein the person-details updating message includes information of an overall-attention vehicle model of the target person.

In some examples, the apparatus further includes:

an updating module 53 configured to update a person-information interface of the target person based on the person-details updating message.

In some examples, the apparatus further includes:

an inputting module 54 configured to receive query conditions, wherein the query conditions include at least identification information of the target person; and
the communicating module 51 is further configured to send the query conditions to the server, so that the server queries for the attention vehicle model of the target person according to the query conditions.

Those skilled in the art should understand that implementation functions of each processing module in the data processing apparatus shown in FIG. 5 may be understood with reference to the relevant description of the data processing method. Those skilled in the art should understand that functions of each processing unit in the data processing apparatus shown in FIG. 5 may be implemented by a program running on a processor, or by a specific logic circuit.

In practical applications, all specific structures of the communicating module 51, the displaying and processing module 52, the updating module 53 and the inputting module 54 may correspond to the processor. The specific structure of the processor may be a CPU, an MCU, a DSP, a PLC, electronic components having a processing function or collections of the electronic components. The processor includes an executable code. The executable code is stored in a storage medium. The processor may be connected to the storage medium through a communication interface such as a bus. When corresponding functions of each specific unit are performed, the executable code is read from the storage medium and executed. A part of the storage medium for storing the executable code is preferably a non-transitory storage medium.

The data processing apparatus provided by the example of the present application may display the tag information of the target person including the attention vehicle model, which is convenient for the sales personnel to know the attention vehicle model of the target person in time and provide the target person with targeted service based on the attention vehicle model of the target person, improving the target person's experience and sales conversion rate.

An example of the present application also describes a data processing apparatus. The apparatus includes a memory, a processor and a computer program stored in the memory and running on the processor, wherein the program is executed by the processor to implement the data processing method provided in any of the technical solutions as described above.

In an example, the program is executed by the processor to:

receive tag information indicating an attention vehicle model of a target person sent by a server; and
display the tag information on a first interface,
wherein the attention vehicle model of the target person is determined by the server based on stay time length information of the target person for a plurality of vehicle models.

In an example, the program is executed by the processor to:

receive a person-details updating message of the target person sent by the server, wherein the person-details updating message includes information of an overall-attention vehicle model of the target person; and
update a person-information interface of the target person based on the person-details updating message.

In an example, the program is executed by the processor to:

receive query conditions, wherein the query conditions include at least identification information of the target person; and
send the query conditions to the server, so that the server queries for the attention vehicle model of the target person according to the query conditions.

The data processing apparatus provided by the example of the present application may display the tag information of the target person including the attention vehicle model, which is convenient for the sales personnel to know the attention vehicle model of the target person in time and provide the target person with targeted services based on the attention vehicle model of the target person, improving the target person's experience and sales conversion rate.

An example of the present application also describes a computer storage medium in which computer executable instructions are stored. The computer executable instructions are used to implement the data processing method applied to a server side as described in the examples. That is to say, the computer executable instructions are executed by a processor to implement the data processing method applied to the server side provided by any of the technical solutions as described above.

Those skilled in the art should understand that functions of each program in the computer storage medium in this example may be understood with reference to the relevant description of the data processing method applied to the server side in the examples as described above.

An example of the present application also describes a computer storage medium in which computer executable instructions are stored. The computer executable instructions are used to implement the data processing method applied to a terminal side as described in the examples. That is to say, the computer executable instructions are executed by a processor to implement the data processing method applied to the terminal side provided by any of the technical solutions as described above.

Those skilled in the art should understand that functions of each program in the computer storage medium in this example may be understood with reference to the relevant description of the data processing method applied to the terminal side in the examples as described above. The computer storage medium may be a volatile computer readable storage medium or a non-volatile computer readable storage medium.

An example of the present disclosure also provides a computer program product, which includes computer readable codes. The computer readable codes, when running in a device, are executed by a processor in the device to implement the data processing method provided in any of the examples as described above.

The computer program product may be specifically implemented by hardware, software or a combination thereof. In an alternative example, the computer program product is specifically embodied as a computer storage medium. In another alternative example, the computer program product is specifically embodied as a software product, for example, a Software Development Kit (SDK).

Those skilled in the art should understand that functions of each program in the computer storage medium in this example may be understood with reference to the relevant description of the data processing method in the examples as described above.

In several examples provided in this application, it should be understood that the disclosed device and method may be implemented in other ways. The device examples described above are only schematic. For example, the division of units is only the division of logical functions, and in actual implementation, there may be other division manners, for example, multiple units or components may be combined, or integrated into another system, or some features may be ignored, or not be implemented. In addition, the coupling or direct coupling or communication connection between displayed or discussed components may be through some interfaces, and the indirect coupling or communication connection between devices or units may be electrical, mechanical or in other forms.

The units described as separate components may or may not be physically separated, and the components displayed as units may or may not be physical units, which may be located in one place or may be distributed to multiple network units. Some or all of the units may be selected according to actual needs to achieve the objectives of the present application.

In addition, all functional units in the examples of the present application may be integrated into one processing unit, or each unit may be used separately as one unit, or two or more units may be integrated into one unit. The integrated units may be implemented in the form of hardware, or in the form of hardware and software functional units.

Those of ordinary skill in the art may understand that all or part of steps to implement the method examples may be completed by program instructions related hardware. The program may be stored in a computer readable storage medium, and the program is executed to perform steps including the steps in the method examples. The storage medium includes a mobile storage device, a Read-Only Memory (ROM), a Random Access Memory (RAM), a magnetic disk or an optical disc, and other media that can store program codes.

Alternatively, the integrated units in this application, if being implemented in the form of software functional modules and sold or used as independent products, may also be stored in a computer readable storage medium. Based on this understanding, the technical solutions in the examples of the present application in essence or a part thereof that contributes to the prior art may be embodied in the form of a software product. The computer software product is stored in a storage medium, including several instructions for enabling a computer device, which may be a personal computer, a server, a network device or the like, to perform all or part of the methods described in the examples of the present application. The storage medium includes a mobile storage device, an ROM, an RAM, a magnetic disk or an optical disc, and other media that can store program codes.

The above are only the specific examples of the present application, but the protection scope of this application is not limited thereto. All changes or replacements that any person skilled in the art can readily envisage within the technical scope disclosed in this application shall be contained in the protection scope of the application. Therefore, the protection scope of the present application shall be based on the protection scope of the claims.

### INDUSTRIAL PRACTICABILITY

According to the technical solutions provided in the examples of the present application, the stay time length information of the target person for the plurality of vehicle models is obtained, wherein the stay time length information is determined based on the at least one visit of the target person; the attention vehicle model of the target person is determined based on the stay time length information; and the information of the attention vehicle model of the target person is sent to the terminal, so that the terminal displays the information of the attention vehicle model of the target person on the first interface. In this way, by analyzing a stay time length of each target person for different vehicle models, an attention vehicle model of each target person is determined, which is convenient for the sales personnel to provide the target person with targeted service easily based on the attention vehicle model of the target person, improving a target person experience and a sales conversion rate.

1. A data processing method, comprising:
identifying a target person from a captured video stream to obtain stay time length information of the target person for each of a plurality of vehicle models during at least one visit;
generating tag information indicating an attention vehicle model of the target person based on the stay time length information for each vehicle model; and
sending the tag information to a terminal provided with a first interface, so that the terminal displays the tag information on the first interface.

2. The method according to claim 1, wherein generating the tag information indicating the attention vehicle model of the target person based on the stay time length information for each vehicle model comprises:
determining the attention vehicle model of the target person based on the stay time length information for each vehicle model;
generating the tag information based on the information of the attention vehicle model of the target person,
wherein the tag information comprises a stay time of the target person for the attention vehicle model.

3. The method according to claim 2, wherein determining the attention vehicle model of the target person based on the stay time length information for each vehicle model comprises:
determining a current attention vehicle model of the target person based on an accumulated stay time for which the target person stays in a vehicle model area corresponding to each of the plurality of vehicle models in a current visit;
wherein the tag information comprises information of the current attention vehicle model of the target person;
sending the tag information to the terminal comprises:
in response to detecting a next visit of the target person, sending a person visit notifying message to the terminal, wherein the person visit notifying message comprises the tag information.

4. The method according to claim 2, wherein determining the attention vehicle model of the target person based on the stay time length information for each vehicle model comprises:
determining an overall-attention vehicle model of the target person based on an accumulated stay time for which the target person stays in a vehicle model area corresponding to each of the plurality of vehicle models in a current visit and at least one historical visit within a preset time period;
wherein the tag information comprises information of the overall-attention vehicle model of the target person;
sending the tag information to the terminal comprises:
sending a person-details updating message to the terminal, wherein the person-details updating message comprises the tag information, so that the terminal updates a person-information interface of the target person.

5. The method according to claim 4, wherein determining the overall-attention vehicle model of the target person based on the accumulated stay time for which the target person stays in a vehicle model area corresponding to each of the plurality of vehicle models in the current visit and the at least one historical visit within the preset time period, comprises:
obtaining historical accumulated-stay-time information of the target person in the vehicle model area corresponding to each of the plurality of vehicle models in the at least one historical visit within the preset time period;
obtaining updated accumulated-stay-time information of the target person based on an accumulated stay time for which the target person stays in the vehicle model area corresponding to each of the plurality of vehicle models in the current visit and the historical accumulated-stay-time information; and
determining the overall-attention vehicle model of the target person based on the updated accumulated-stay-time information of the target person.

6. The method according to claim 1, wherein identifying a target person from a captured video stream to obtain stay time length information of the target person for each of a plurality of vehicle models during at least one visit, further comprises:
performing identification processing on a captured video stream to obtain at least one image frame in which the target person appears in at least one visit; and
determining a stay time length of the target person for each of the plurality of vehicle models based on capturing time of the at least one image frame in which the target person appears and location information of the target person in each image frame.

7. The method according to claim 6, wherein determining the stay time length of the target person for each of the plurality of vehicle models comprises:
obtaining time information and location information corresponding to each appearance of the target person in the at least one image frame;
determining the vehicle model area corresponding to each appearance based on the location information of each appearance of the target person and the vehicle model areas corresponding to the plurality of vehicle models; and
determining the stay time length of the target person for each of the plurality of vehicle models based on the time information corresponding to each appearance and the vehicle model area corresponding to each appearance.

8. The method according to claim 7, wherein determining the stay time length of the target person for each of the plurality of vehicle models based on the time information corresponding to each appearance and the vehicle model area corresponding to each appearance comprises:
in response to that vehicle model areas corresponding to adjacent appearances of the target person are the same and a time difference between the adjacent appearances is less than or equal to a preset time threshold, counting the time difference between the adjacent appearances into a stay time length of the target person for a corresponding vehicle model area.

9. The method according to claim 7, wherein determining the stay time length of the target person for each of the plurality of vehicle models based on the time information corresponding to each appearance and the vehicle model area corresponding to each appearance comprises:
in response to that the time difference between the adjacent appearances of the target person is greater than the preset time threshold, determining not to count the time difference between the adjacent appearances into the stay time length of the target person for the corresponding vehicle model area.

10. The method according to claim 1, further comprising:
receiving query conditions sent by the terminal, wherein the query conditions comprise at least identification information of the target person.

11. The method according to claim 10, wherein the query conditions further comprise at least one of the following:
a visited store name;
a visit time; or
reception personnel identification.

12. The method according to claim 2, wherein determining the attention vehicle model of the target person based on the stay time length information for each vehicle model comprises:
sorting the plurality of vehicle models based on the stay time length information of the target person for each of the plurality of vehicle models to obtain an attention vehicle model list of the target person;
wherein the tag information further comprises at least a part of the attention vehicle model list of the target person.

13. A data processing method, applicable to a terminal, and comprising:
receiving tag information indicating an attention vehicle model of a target person sent by a server; and
displaying the tag information on a first interface,
wherein the attention vehicle model of the target person is determined by the server based on stay time length information of the target person for each of a plurality of vehicle models.

14. The method according to claim 13, further comprising:
receiving a person-details updating message of the target person sent by the server, wherein the person-details updating message comprises information of an overall-attention vehicle model of the target person; and
updating a person-information interface of the target person based on the person-details updating message.

15. The method according to claim 13, further comprising:
receiving query conditions, wherein the query conditions comprise at least identification information of the target person; and
sending the query conditions to the server, so that the server queries for the attention vehicle model of the target person according to the query conditions.

16. A data processing apparatus, comprising:
a processor;
a non-transitory memory storing computer program;
wherein, by executing the computer program, the processor is caused to:
identify a target person from a captured video stream to obtain stay time length information of the target person for each of a plurality of vehicle models during at least one visit;
generate tag information indicating an attention vehicle model of the target person based on the stay time length information for each vehicle model; and
send the tag information to a terminal provided with a first interface, so that the terminal displays the tag information on the first interface.

17. The apparatus according to claim 16, wherein when generating the tag information indicating the attention vehicle model of the target person based on the stay time length information for each vehicle model, the processor is further caused to:
determine the attention vehicle model of the target person based on the stay time length information for each vehicle model;
generate the tag information based on the information of the attention vehicle model of the target person,
wherein the tag information comprises a stay time of the target person for the attention vehicle model.

18. The apparatus according to claim 17, wherein when determining the attention vehicle model of the target person based on the stay time length information for each vehicle model, the processor is further caused to:
determine a current attention vehicle model of the target person based on an accumulated stay time for which the target person stays in a vehicle model area corresponding to each of the plurality of vehicle models in a current visit;
wherein the tag information comprises information of the current attention vehicle model of the target person;
when sending the tag information to the terminal, the processor is further caused to:
in response to detecting a next visit of the target person, send a person visit notifying message to the terminal, wherein the person visit notifying message comprises the tag information.

19. The apparatus according to claim 17, wherein when determining the attention vehicle model of the target person based on the stay time length information for each vehicle model, the processor is further caused to:
determine an overall-attention vehicle model of the target person based on an accumulated stay time for which the target person stays in a vehicle model area corresponding to each of the plurality of vehicle models in a current visit and at least one historical visit within a preset time period;
wherein the tag information comprises information of the overall-attention vehicle model of the target person;
when sending the tag information to the terminal, the processor is further caused to:
send a person-details updating message to the terminal, wherein the person-details updating message comprises the tag information, so that the terminal updates a person-information interface of the target person.

20. A non-transitory computer storage medium having computer executable instructions stored thereon, wherein the computer executable instructions are executed by a processor to implement the method of claim 1.
